(19) United States
(12) Patent Application Publication
(10) Pub. No.: US 2019/0254263 A1
(43) Pub. Date: Aug. 22, 2019

(54) METHOD, SYSTEM AND APPARATUS FOR ZERO OVERFLOW

(71) Applicant: GASTON BIANCHI, Hialean, FL (US)

(72) Inventor: GASTON BIANCHI, Hialean, FL (US)

(21) Appl. No.: 16/249,182

(22) Filed: Jan. 16, 2019

Related U.S. Application Data
(60) Provisional application No. 62/709,489, filed on Jan. 22, 2018.

(51) Int. Cl. A01K 63/04

(52) U.S. Cl. CPC A01K 63/045; A01K 63/047

(57) ABSTRACT

As with conventional units, it can be produced at any range of sizes and shapes in both glass and acrylic versions. The whole concept idea is to eliminate any apparatus attachment from the inside space of an aquarium obstructing the habitat or aqua-scape and to give best performance to all new aquariums. For its simplicity and safe operation, it does not require any combination of chambers or attachments that require assembling or connections between them via bulkheads, fittings or any other sort of plumbing in order to enable water into the external box and drain down into a filtration system to create its cycle and be pumped back up again to the aquarium. It will differ through its incorporations of a series of short, vertically oriented, narrow slots arranged in a horizontal row at a point near the upper end of its rear panel.

### CROSS-REFERENCE TO RELATED APPLICATION

Claiming Priority to U.S. 62/709,489

### SEQUENCE LISTING OR PROGRAM

Not Applicable

### BACKGROUND

### Field

This application relates to Zero Overflow.

### SUMMARY

This information summary relates to a product modification called “ZERO OVERFLOW” which is been disclose to USPTO by Mr. Gaston D. Bianchi of Hialeah Florida. The result is a reference tool which can be used to submit “ZERO OVERFLOW” to industry in a logical format which stresses it positive and most appealing features.

### DESCRIPTION: PRODUCT CONCEPT REVIEW

In this information summary, we will review the distinctive features of the product modifications and the needs it might fulfill. The concept of “ZERO OVERFLOW” is an improved aquarium overflow box re designed. As with conventional units, it can be produced at any range of sizes and shapes in both glass and acrylic versions. The whole concept idea is to eliminate any apparatus attachment from the in-side space of an aquarium obstructing the habitat or aqua-scape and to give a modern look, slick feel and best performance to all new aquariums. For its unique simplicity and safe operation, it does not require any combination of chambers or attachments that require assembling or connections between them via bulkheads, fittings or any other sort of plumbing in order to enable water into the external box and drain down into a filtration system to create its cycle and be pumped back up again to the aquarium.

It will differ through its incorporations of a series of short, vertically oriented, narrow slots arranged in a horizontal row at a point near the upper end of its rear panel. Mounted on the rear side of this panel would be a rectangular external box permanently assembled that would measure approximately three to four times the height of the slots (Weir drain). This would be rendered of the same material as the rest of the unit. Past the outer ends of this called “ZERO OVERFLOW” would be a set of round ports designed for routing return lines.

This Zero Overflow Product is also being manufactured in two versions:

1. The previously described above called “ZERO OVERFOW”.

2. Is the called “HYBRID ZERO OVERFOW” version, differing through its incorporated oval notch at a point near the upper end of its rear panel, with an acrylic removable insert of a series of short, vertically oriented, narrow slots arranged in a horizontal row.

Function and Appealing Features:

Convenience: This design does not occupy any space from the inside capacity of the aquarium, allowing hobbyists to create a functional aqua-scape raising from the bottom towards the top of the aquarium without being obstructed by any apparatus or combined assembled chambers for this matter.

Safety: The horizontal row of slots vertically oriented are designed to enable water to flow freely through them and at the same time prevent living plants, fishes, corals or any other animals of the habitat from going through.

Statistics: As different size aquariums require a specific amount of water volume flowing through, this called “ZERO OVERFLOW” can handle a much greater (gph) gallons per hour as any other conventional overflow.

A modern look and slick feel eliminating any apparatus attachment obstructing the habitat of living animals.

Historical Development:

I Gaston D. Bianchi identified a need or a problem to be solved, that prompted me into the invention process. Then I conceived “ZERO OVERFLOW” and created a prototype, because of its visibility and tangibility, makes easier for anyone who may become interested in the idea or to have a clearer understanding of its concept and purpose. Subsequently, sketches, drawing, pictures and a written description were prepared for review.

### DRAWINGS—FIGURES

The Method, System and Apparatus of a Zero Overflow is described in the following drawings which are described briefly as follows:

FIG. 1: View of a finished Zero Overflow with removable lid, return muzzle. external box, and 24″ row of slots zero flow.

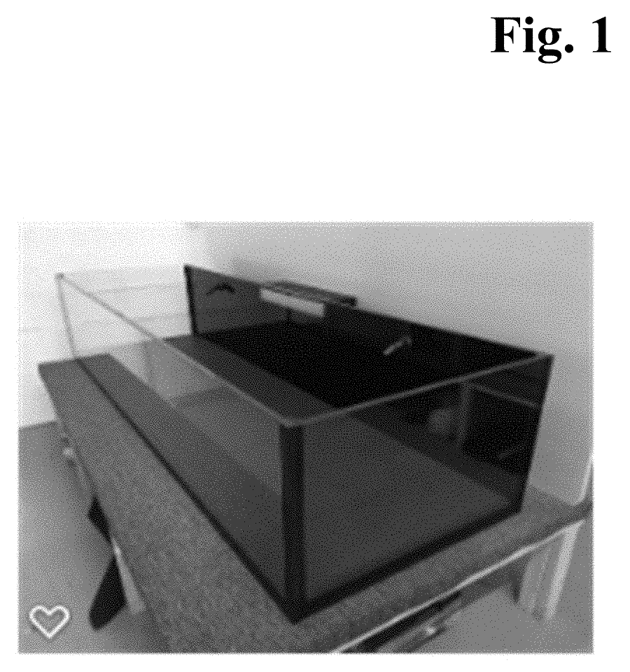

FIG. 2:Zero overflow slot cuts with Port holes;

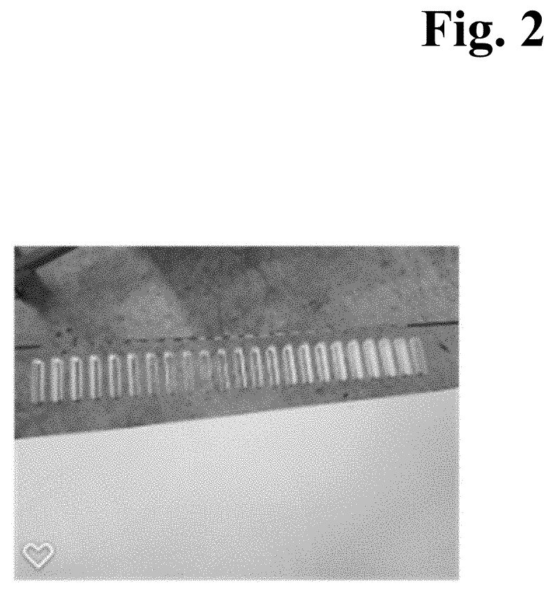

FIG. 3: Port Holes details;

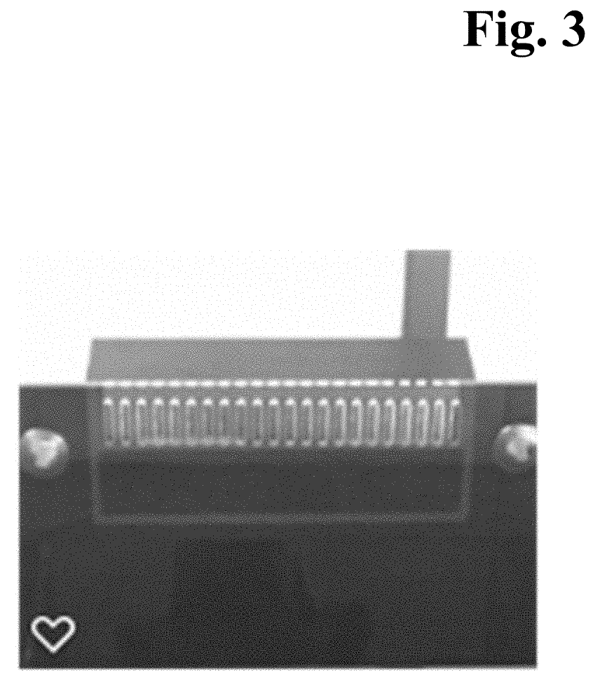

FIG. 4: Port holes return mozzles;

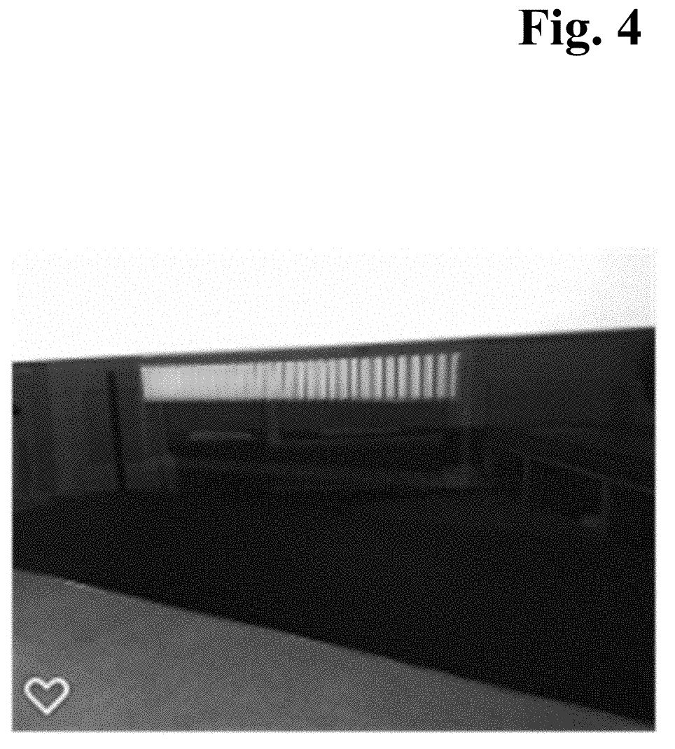

FIG. 5: 16″ row of slots zero overflow;

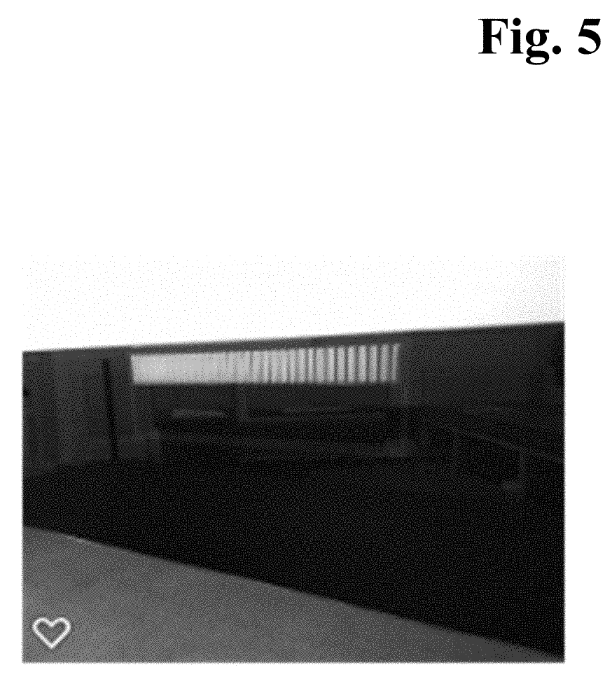

FIG. 6: External box to be assembled on the back of zero overflow slots;

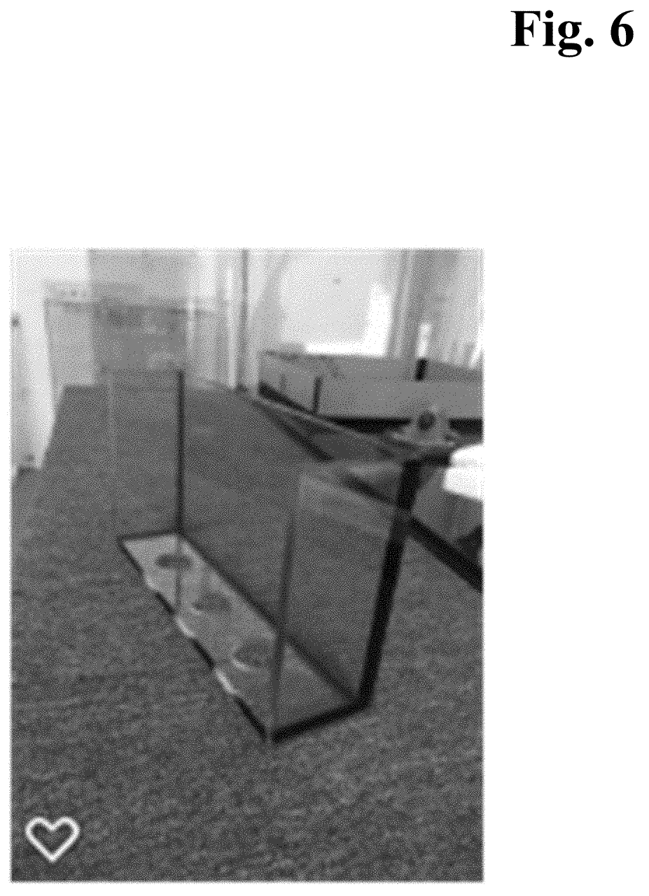

FIG. 7: External box fully assembled;

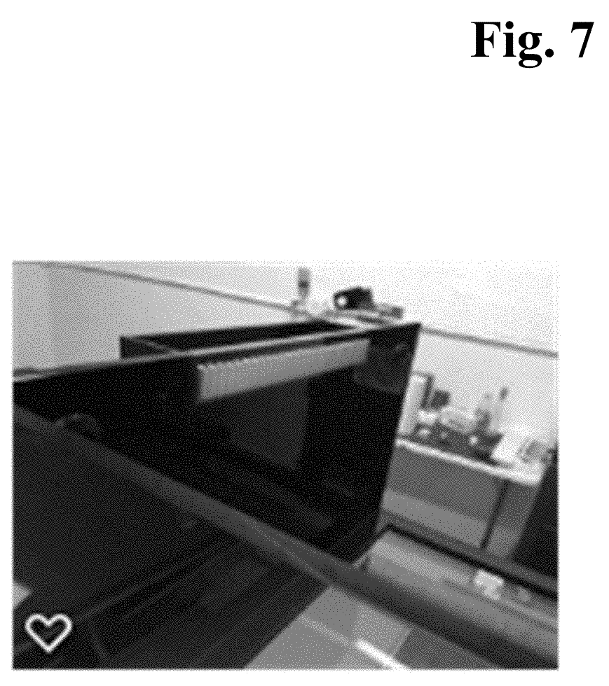

FIG. 8: Drainage pipes to filtration system;

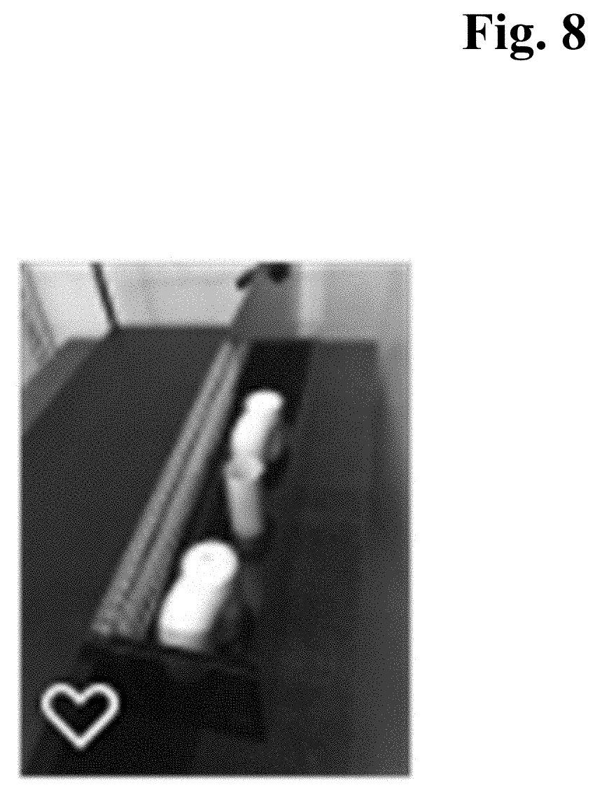

FIG. 9: External box fully assembled;

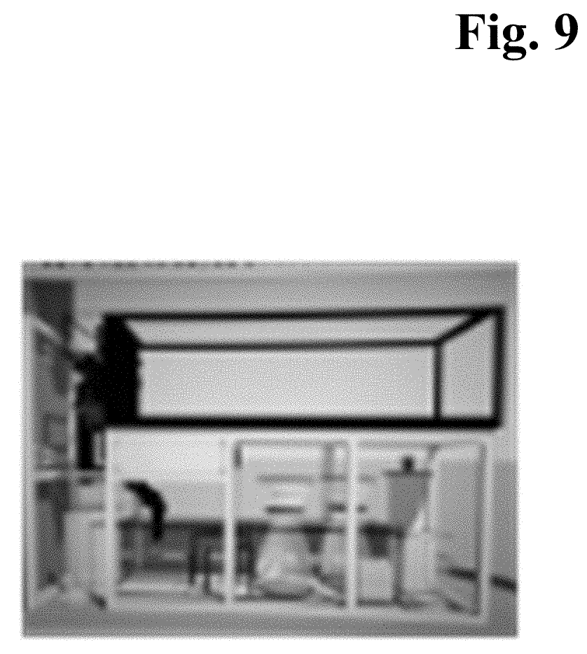

FIG. 10: Zero overflow, external box viewed from behind;

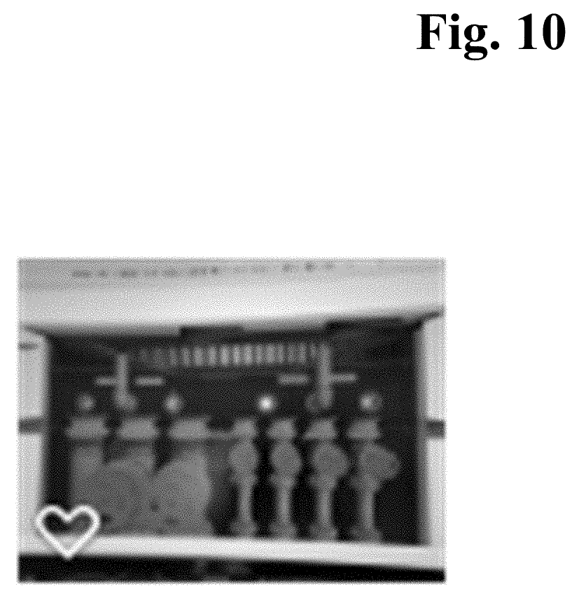

FIG. 11: Drainage pipes;

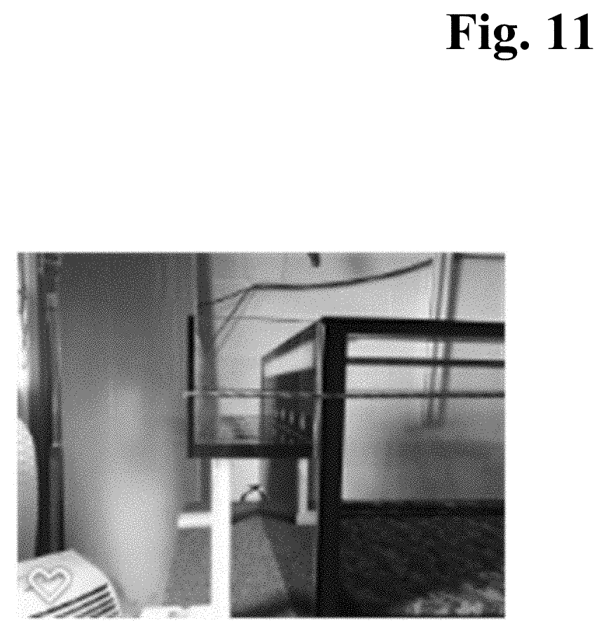

FIG. 12: 72″ long×2″ tall

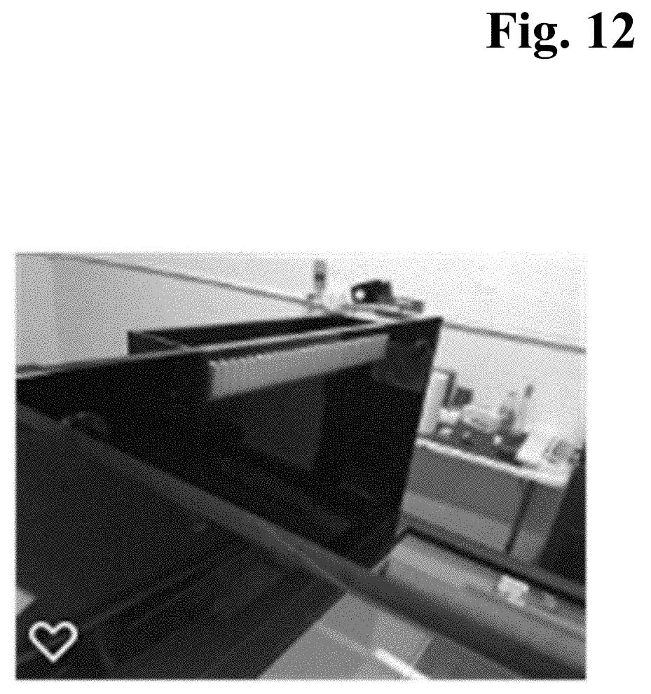

I claim:

1. Zero overflow provide high capacity flowing without the need to attach secondary filtration systems.
